(19) United States
(12) Patent Application Publication
(10) Pub. No.: US 2020/0247247 A1
(43) Pub. Date: Aug. 6, 2020

(54) INTEGRATED VEHICLE WIRELESS CHARGING SYSTEM AND METHOD FOR USING SAME

(71) Applicant: Elix Wireless Charging Systems Inc., Vancouver (CA)

(72) Inventors: Allen James UPWARD, Vancouver (CA); Boon Chong NG, Vancouver (CA); Brice JAMIESON, Richmond (CA); Arash AHMADI, West Vancouver (CA); Abdurakhman SMAZOV, Burnaby (CA)

(21) Appl. No.: 16/265,916

(22) Filed: Feb. 1, 2019

(51) Int. Cl. B60L 53/122; B60L 53/24; H02J 7/02; H02J 7/14; H02P 29/68

(52) U.S. Cl. CPC B60L 53/122; B60L 53/24; H02P 29/68; H02J 7/14; H02J 7/025

(57) ABSTRACT

A wireless power receiving system for an electric vehicle comprises an electric traction motor for providing mechanical energy for propelling the vehicle. The electric traction motor is operable as a generator to convert received mechanical energy into electrical energy. An inverter is connectable to receive input electric energy from the electric traction motor when the electric traction motor operates as a generator and is operative to output electric charging energy in response to the input electric energy. A battery is connectable to receive the electric charging energy from the inverter. A regenerative braking (RB) mechanical power transfer mechanism is connected to mechanically couple RB mechanical energy from a drivetrain of the electric vehicle to the electric traction motor. A MDC mechanical power transfer mechanism is connected to mechanically couple MDC mechanical energy from a magneto-dynamic coupling (MDC) wireless power receiver to the electric traction motor.

### TECHNICAL FIELD

This application pertains to a wireless vehicle charging system. Particular embodiments pertain to integrating a wireless vehicle charging system with a powertrain of an electric vehicle.

### BACKGROUND

Increasing production of battery-powered electric vehicles (EVs) for transportation has created demand for lower-cost electric charging systems to supply the electrical energy required to charge batteries on board these vehicles. EVs may include, but are not limited to, automobiles, buses, trucks, locomotives, motorcycles, scooters, golf carts, tractors, snowmobiles, boats, planes etc. and may include both completely electric vehicles and hybrid vehicles that may include a combustion engine or otherwise but which have electric traction motors that deliver mechanical energy to a drivetrain of the hybrid vehicle.

Typical EVs contain several on board electrical systems for performing the following vehicle functions: propulsion, regenerative braking (regen), and wired (on-board) charging. The vehicle battery can be charged by either a wired charging connection or the regenerative system. Typical EV charging rates tend to vary based on a number of factors including: size of the EV battery, grid power supply, and the EV usage profile. Typical EV traction motors used for propulsion are specified using a number of performance factors, including: EV weight, speed, and load conditions during operation. In most cases, the power rating of the vehicle traction motor and its associate propulsion/regenerative systems are larger than the power rating for wired-charging systems for a given EV (e.g., a 2017 Nissan Leaf has an 80 kW traction motor and a maximum wired charging rate of 44 kW using the CHAdeMO inlet). This characteristic presents an opportunity to use the high-power propulsion/regenerative systems to charge the EV batteries at an equivalent or higher rate than the existing wired charging systems.

In U.S. Pat. No. 8,174,231, Sandberg et al. describe a method for transferring power from a first stationary vehicle to a second stationary vehicle by rotating the wheels of the first vehicle which are mechanically linked with a roller coupling to the wheels of the second vehicle. This mechanical rotational force is then converted to electrical energy by the regenerative system on the first vehicle. In U.S. Pat. No. 8,330,411, Pellen teaches a mechanical system for transferring power underwater from a first motor to an underwater electrical vehicle by using an underwater docking station, a slide, and a mechanical coupling. Both of the preceding patents require very precise positional alignment between the power transmitting device and receiving device to function, which increases cost, and limits the application with conventional vehicles. The use of mechanical rollers and other mechanical couplers introduces additional component wear which will shorten the life of existing drive train components.

Power can be wirelessly conveyed from one place to another using the Faraday effect, whereby a changing magnetic field causes an electrical current to flow in an electrically isolated secondary circuit. A form of wireless power transfer (WPT) currently in use involves magnetic inductive charging. One form of magnetic inductive charging is shown in WPT system 10 of FIG. 1. The FIG. 1 WPT system 10 comprises two coils 12, 14 in close proximity but separated by an air gap 16. One coil 12 of WPT system 10 acts as a wireless power transmitter and the other coil 14 acts as the receiver of wireless power. A time-varying current flows in transmitter coil 12, which produces a time-varying magnetic field (shown as flux lines in FIG. 1). This time-varying magnetic field induces current in the nearby receiver coil 14 (Faraday's law), which can then be used to charge various devices (not shown) which may be electrically connected to receiver coil 14.

In PCT application No. PCT/CA2010/000252 (published under WO/2010/096917), a magneto-dynamic coupling (MDC) technology has been described to provide a number of viable WPT systems that can be used to charge, by way of non-limiting example, batteries generally, electric (e.g. battery operated) vehicles, auxiliary batteries, electric (e.g. battery operated) buses, golf carts, delivery vehicles, boats, drones, trucks and/or the like. FIG. 2 schematically depicts a WPT system 20 incorporating a magnetic-coupling technology of the type described in PCT/CA2010/000252. WPT system 20 comprises a wireless magnetic power transmitter 22 and a wireless magnetic power receiver 24 separated by an air gap 26. The power transfer in WPT system 20 is via rotational magnetic coupling rather than via direct magnetic induction. In the FIG. 2 WPT system 20, transmitter 22 comprises a permanent magnet 22A and receiver 24 comprises a permanent magnet 24A. Transmitter magnet 22A is rotated (and/or pivoted) about axis 28. The magnetically coupled permanent magnets 22A, 24A interact with one another (magnetic poles represented by an arrow with notations of “N” for north and “S” for south in FIG. 2), such that movement of transmitter magnet 22A about axis 28 causes corresponding movement (e.g. rotation and/or pivotal movement) of receiver magnet 24A about axis 27. The time-varying magnetic fields generated by rotating/pivoting magnets 22A, 24A of WPT system 20 typically has a lower frequency compared to WPT systems based on magnetic induction.

There is a general desire to integrate wireless power receivers and wireless power receiving systems into EVs and powertrains of EVs. There is a general desire to reduce the volumetric footprint of wireless power receivers and wireless power receiving systems integrated into EVs and powertrains of EVs. There is a general desire to reduce the mass of wireless power receivers and wireless power receiving systems integrated into EVs and powertrains of EVs and powertrains of EVs. There is a general desire to reduce the cost of wireless power receivers and wireless power receiving systems integrated into EVs and powertrains of EVs. There is a general desire to reduce the number of parts required to integrate wireless power receivers and wireless power receiving systems into EVs and powertrains of EVs.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a wireless power receiving system for an electric vehicle. The system comprising an electric traction motor for providing mechanical energy for propelling the vehicle. The electric traction motor is operable as a generator to convert received mechanical energy into electrical energy. An inverter is connectable to receive input electric energy from the electric traction motor when the electric traction motor operates as a generator and operative to output electric charging energy in response to the input electric energy. A battery is connectable to receive the electric charging energy from the inverter. The system comprises magneto-dynamic coupling (MDC) wireless power receiver wirelessly magnetically couplable to a MDC wireless power transmitter for generating MDC mechanical energy by the magnetic coupling. A regenerative braking (RB) mechanical power transfer mechanism is connected to mechanically couple RB mechanical energy from a drivetrain of the electric vehicle to the electric traction motor when the system is in a RB charging mode. A MDC mechanical power transfer mechanism is connected to mechanically couple the MDC mechanical energy from the MDC wireless power receiver to the electric traction motor when the system is in a MDC charging mode.

In some embodiments, the MDC mechanical power transfer mechanism comprises a first clutch connected between the MDC wireless power receiver and the electric traction motor. The first clutch is selectively engageable to mechanically couple the MDC mechanical energy from the MDC wireless power receiver to the electric traction motor via a first rotary connection between the MDC wireless power receiver and the electric traction motor. The first clutch is selectively disengageable to mechanically decouple the MDC wireless power receiver from the electric traction motor. In some embodiments, the first clutch comprises an electromagnetic clutch.

In some embodiments, the RB mechanical power transfer mechanism comprises a second clutch connected between the drivetrain and the electric traction motor. The second clutch is selectively engageable to mechanically couple the RB mechanical energy from the drivetrain to the electric traction motor via a second rotary connection between the drivetrain and the electric traction motor. The second clutch is selectively disengageable to mechanically decouple the drivetrain from the electric traction motor. In some embodiments, the second clutch comprises an electromagnetic clutch.

In some embodiments, the wireless power receiving system includes a cooling system connected to remove heat from the electric traction motor. In some embodiments, the cooling system is connected to remove heat from the electric traction motor when the system is in the MDC charging mode. In some embodiments, the cooling system is connected to remove heat from the electric traction motor when the system is in the RB charging mode. In some embodiments, the cooling system is connected to remove heat from the electric traction motor when the electric traction motor provides mechanical energy to the drivetrain for propelling the vehicle. In some embodiments, the cooling system is connected to remove heat from the inverter.

In some embodiments, the wireless power receiving system comprises a proximity system that includes a proximity transmitter for generating signals which are receivable by a detector of a charging station to position the MDC wireless power receiver relative to the charging station to achieve effective energy transfer between a MDC wireless power transmitter of the charging station and the MDC wireless power receiver. In some embodiments, an electronic control unit is configured to switch from the RB charging mode to the MDC charging mode in response to a first signal from the proximity system. In some embodiments, an electronic control unit is configured to switch from the MDC charging mode to the RB charging mode in response to a second signal from the proximity system.

In some embodiments, the MDC wireless power receiver comprises a rotor comprising one or more permanent magnets rotatable about an axis in response to a magnetic field.

In some embodiments, the MDC wireless power receiver and the electric traction motor are housed by a common casing. In some embodiments, the MDC mechanical power transfer mechanism comprises a direct link between a drive shaft of the electric traction motor and a rotor of the MDC wireless power mechanism.

Another aspect of the invention comprises an electric vehicle comprising any of the wireless power receiving systems disclosed herein.

Another aspect of the invention provides a method of charging an electric vehicle in a magneto-dynamic coupling (MDC) charging mode and a regenerative braking (RB) charging mode. The method comprising providing an electric traction motor for providing mechanical energy for propelling the vehicle, the electric traction motor operable as a generator to convert received mechanical energy into electrical energy, an inverter connectable to receive input electric energy from the electric traction motor when the electric traction motor operates as a generator and operative to output electric charging energy in response to the input electric energy, and a battery connectable to receive the electric charging energy from the inverter. In the MDC charging mode, MDC mechanical energy is generated by a MDC wireless power receiver magnetically coupled (wirelessly) to a MDC wireless power transmitter to thereby generate the MDC mechanical energy and the MDC wireless power receiver is coupled to the electric traction motor to thereby transfer the MDC mechanical energy to the electric traction motor. In the RB charging mode, a drivetrain of the vehicle is coupled to the electric traction motor to thereby transfer RB mechanical energy to the electric traction motor. In some embodiments, MDC mechanical energy comprises rotational mechanical energy.

In some embodiments, the MDC wireless power receiver to the electric traction motor comprises engaging a first clutch. In some embodiments, the first clutch is an electromagnetic clutch. In some embodiments, coupling the drivetrain to the electric traction motor comprises engaging a second clutch. In some embodiments, the second clutch is an electromagnetic clutch. In some embodiments, in the MDC charging mode, the method includes disengaging the second clutch to mechanically decouple the drivetrain from the electric traction motor. In some embodiments, in the RB charging mode, the method includes disengaging the first clutch to mechanically decouple the MDC wireless power receiver from the electric traction motor.

In some embodiments, the electric vehicle comprises a cooling system. In some embodiments, in the MDC charging mode, the cooling system is used to remove heat from the electric traction motor. In some embodiments, in the RB charging mode, the cooling system is used to remove heat from the electric traction motor. In some embodiments, the cooling system is used to remove heat from the electric traction motor while the electric traction motor provides mechanical power to the drivetrain. In some embodiments, the cooling system is used to remove heat from the inverter.

In some embodiments, the method of charging an electric vehicle includes transmitting signals from a proximity transmitter of a proximity system in the vehicle to a detector of a charging station to position the MDC wireless power receiver relative to a MDC wireless power transmitter of the charging station to achieve effective energy transfer between the MDC wireless power transmitter of the charging station and the MDC wireless power receiver. In some embodiments, the method of charging an electric vehicle includes switching from the RB charging mode to the MDC charging mode in response to a first signal from the proximity system. In some embodiments, the method of charging an electric vehicle includes switching from the MDC charging mode to the RB charging mode in response to a second signal from the proximity system.

Another aspect of the invention provides a wireless power receiving system for an electric vehicle. The system includes an electric traction motor for providing mechanical energy for propelling the vehicle, the electric traction motor operable as a generator to convert received mechanical energy into electrical energy and an auxiliary generator for converting received mechanical energy into electrical energy. The system also includes an inverter connectable to receive first input electric energy from the electric traction motor when the electric traction motor operates as a generator, and receive second input electric energy from the auxiliary generator. The inverter is operative to output electric charging energy in response to the first input electric energy or the second input electric energy. A battery is connectable to receive the electric charging energy from the inverter. A magneto-dynamic coupling (MDC) wireless power receiver wirelessly magnetically couplable to a MDC wireless power transmitter is provided for generating MDC mechanical energy by the magnetic coupling. A regenerative braking (RB) mechanical power transfer mechanism is connected to mechanically couple RB mechanical energy from a drivetrain of the electric vehicle to the electric traction motor when the system is in a RB charging mode. A MDC mechanical power transfer mechanism is connected to mechanically couple the MDC mechanical energy from the MDC wireless power receiver to the auxiliary generator when the system is in a MDC charging mode.

In some embodiments, the wireless power receiving system includes a cooling system connected to remove heat from the electric traction motor and the auxiliary generator. In some embodiments, the cooling system is connected to remove heat from the auxiliary generator when the system is in the MDC charging mode. In some embodiments, the cooling system is connected to remove heat from the electric traction motor when the system is in the RB charging mode. In some embodiments, the cooling system is connected to remove heat from the electric traction motor when the electric traction motor provides mechanical energy to the drivetrain for propelling the vehicle. In some embodiments, the cooling system is connected to remove heat from the inverter.

In some embodiments, the auxiliary generator is the electric traction motor.

Another aspect of the invention provides a method of charging an electric vehicle in a magneto-dynamic coupling (MDC) charging mode and a regenerative braking (RB) charging mode. The method includes providing an electric traction motor for providing mechanical energy for propelling the vehicle, the electric traction motor operable as a generator to convert received mechanical energy into electrical energy, an auxiliary generator for converting received mechanical energy into electrical energy, and an inverter. The inverter is connectable to receive first input electric energy from the electric traction motor when the electric traction motor operates as a generator and receive second input electric energy from the auxiliary generator. The inverter is operative to output electric charging energy in response to the first input electric energy or the second input electric energy. A battery is connectable to receive the electric charging energy from the inverter. In the MDC charging mode, MDC mechanical energy is generated by a MDC wireless power receiver magnetically coupled (wirelessly) to a MDC wireless power transmitter to thereby generate the MDC mechanical energy and the MDC wireless power receiver is coupled to the auxiliary generator to thereby transfer the MDC mechanical energy to the auxiliary generator. In the RB charging mode, a drivetrain of the vehicle is coupled to the electric traction motor to thereby transfer RB mechanical energy to the electric traction motor.

Another aspect of the invention provides a wireless power receiving system for an electric vehicle. The system includes an electric motor operable as a generator to convert received mechanical energy into electrical energy and an inverter that is part of a regenerative braking (RB) system of the vehicle. The inverter is connectable to receive input electric energy from the electric motor when the electric motor operates as a generator and operative to output electric charging energy in response to the input electric energy. A battery is connectable to receive the electric charging energy from the inverter. The system includes a magneto-dynamic coupling (MDC) wireless power receiver wirelessly magnetically couplable to a MDC wireless power transmitter for generating MDC mechanical energy by a magnetic coupling. A MDC mechanical power transfer mechanism is connected to mechanically couple the MDC mechanical energy from the MDC wireless power receiver to the electric motor when the system is in a MDC charging mode.

In some embodiments, the electric motor is an electric traction motor for providing mechanical energy for propelling the vehicle.

In some embodiments, the system also includes a RB mechanical power transfer mechanism connected to mechanically couple RB mechanical energy from a drivetrain of the electric vehicle to the electric traction motor when the system is in a RB charging mode.

In some embodiments, the electric motor is an auxiliary generator and the system comprises an electric traction motor for providing mechanical energy for propelling the vehicle, the electric traction motor operable as a generator to convert received mechanical energy into electrical energy, a RB mechanical power transfer mechanism connected to mechanically couple RB mechanical energy from a drivetrain of the electric vehicle to the electric traction motor when the system is in a RB charging mode; and an inverter. The inverter is connectable to receive first input electric energy from the electric traction motor, in a RB charging mode, when the electric traction motor operates as a generator and receive second input electric energy from the auxiliary generator in the MDC charging mode. The inverter is operative to output electric charging energy in response to the first input electric energy or the second input electric energy.

Another aspect of the invention provides a method of charging an electric vehicle. The method includes providing an electric motor operable as a generator to convert received mechanical energy into electrical energy, an inverter that is part of a regenerative braking (RB) system of the vehicle connectable to receive input electric energy from the electric motor when the electric motor operates as a generator and operative to output electric charging energy in response to the input electric energy and a battery connectable to receive the electric charging energy from the inverter. In a MDC charging mode, MDC mechanical energy is generated by a MDC wireless power receiver magnetically coupled (wirelessly) to a MDC wireless power transmitter to thereby generate the MDC mechanical energy and the MDC wireless power receiver is coupled to the electric motor and thereby transferring the MDC mechanical energy to the electric motor.

In some embodiments, the electric motor is an electric traction motor for providing mechanical energy for propelling the vehicle.

In some embodiments, in a RB charging mode, a drivetrain of the vehicle is coupled to the electric traction motor to thereby transferring RB mechanical energy to the electric traction motor.

In some embodiments, the electric motor is an auxiliary generator and the method includes providing an electric traction motor for providing mechanical energy for propelling the vehicle, the electric traction motor operable as a generator to convert received mechanical energy into electrical energy, a RB mechanical power transfer mechanism connected to mechanically couple RB mechanical energy from a drivetrain of the electric vehicle to the electric traction motor when the system is in a RB charging mode; and an inverter. The inverter is connectable to receive first input electric energy from the electric traction motor, in a RB charging mode, when the electric traction motor operates as a generator and receive second input electric energy from the auxiliary generator in the MDC charging mode. The inverter is operative to output electric charging energy in response to the first input electric energy or the second input electric energy.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is prior art illustrating the principle of magnetic inductive charging by a power transmitter coil and a wireless power receiver coil in close proximity.

FIG. 2 is prior art illustrating the principle of magnetically-coupling two rotating magnets in a wireless power transfer system.

FIG. 3 is prior art illustrating a power train of an electric vehicle.

FIG. 4A is a schematic representation of a wireless power receiving system according to one embodiment of the invention.

FIG. 4B is a schematic representation of a ground assembly according to one embodiment of the invention.

FIG. 5A is a schematic representation of a wireless power receiving system integrated with a powertrain of an electric vehicle according to one embodiment of the invention.

FIG. 5B is a schematic representation of a ground assembly according to one embodiment of the invention.

FIG. 6A is a schematic representation of a wireless power receiving system integrated with a powertrain of an electric vehicle according to one embodiment of the invention.

FIG. 6B is a schematic representation of a ground assembly according to one embodiment of the invention.

FIG. 7A is a schematic representation of a wireless power receiving system integrated with a powertrain of an electric vehicle according to one embodiment of the invention.

FIG. 7B is a schematic representation of a ground assembly according to one embodiment of the invention.

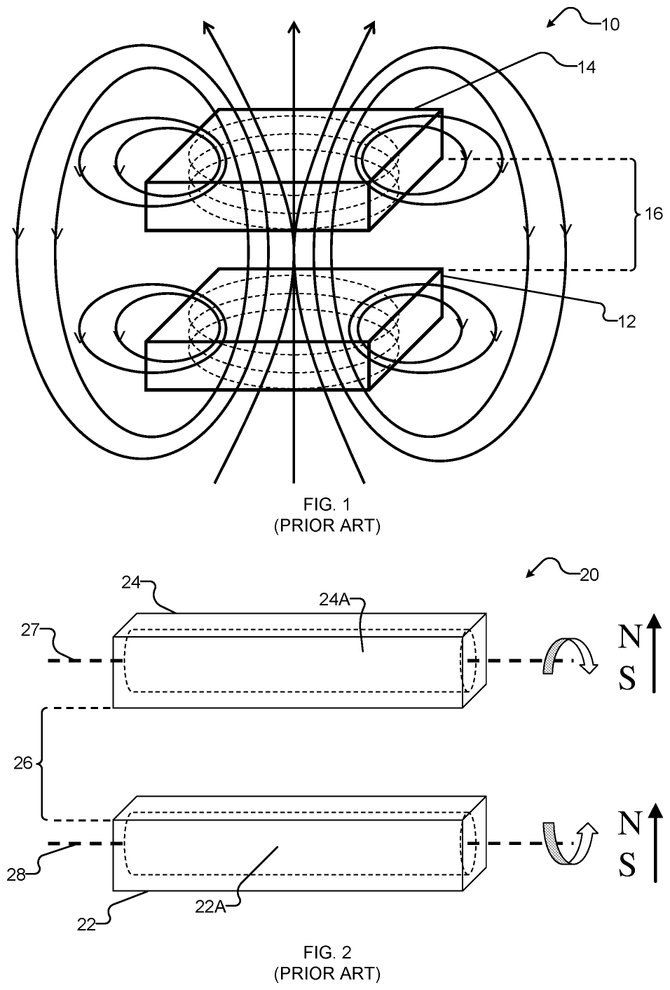

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a wireless power receiving system for an electric vehicle. The system comprises an electric traction motor for providing mechanical energy for propelling the vehicle. The electric traction motor is operable as a generator to convert received mechanical energy into electrical energy. The system comprises an inverter connectable to receive input electric energy from the electric traction motor when the electric traction motor operates as a generator and operative to output electric charging energy in response to the input electric energy. The system comprises a battery connectable to receive the electric charging energy from the inverter. The system comprises a magneto-dynamic coupling (MDC) wireless power receiver for generating MDC mechanical energy by a magnetic coupling. The system comprises a regenerative braking (RB) mechanical power transfer mechanism connected to mechanically couple RB mechanical energy from a drivetrain of the electric vehicle to the electric traction motor when the system is in a RB charging mode. The system comprises a MDC mechanical power transfer mechanism connected to mechanically couple the MDC mechanical energy from the MDC wireless power receiver to the electric traction motor when the system is in a MDC charging mode.

Another aspect of the invention provides wireless power receiving system for an electric vehicle. The system comprises an electric traction motor for providing mechanical energy for propelling the vehicle. The electric traction motor is operable as a generator to convert received mechanical energy into electrical energy. The system comprises an auxiliary generator for converting received mechanical energy into electrical energy. The system comprises an inverter connectable to (1) receive first input electric energy from the electric traction motor when the electric traction motor operates as a generator; and (2) receive second input electric energy from the auxiliary generator. The inverter is operative to output electric charging energy in response to the first input electric energy or the second input electric energy. The system comprises a battery connectable to receive the electric charging energy from the inverter. The system comprises a magneto-dynamic coupling (MDC) wireless power receiver for generating MDC mechanical energy by a magnetic coupling. The system comprises a regenerative braking (RB) mechanical power transfer mechanism connected to mechanically couple RB mechanical energy from a drivetrain of the electric vehicle to the electric traction motor when the system is in a RB charging mode. The system comprises a MDC mechanical power transfer mechanism connected to mechanically couple the MDC mechanical energy from the MDC wireless power receiver to the auxiliary generator when the system is in a MDC charging mode.

Another aspect of the invention provides a method of charging an electric vehicle in a magneto-dynamic coupling (MDC) charging mode and a regenerative braking (RB) charging mode, the method comprising. An electric traction motor is provided. The electric traction motor is for providing mechanical energy for propelling the vehicle, the electric traction motor operable as a generator to convert received mechanical energy into electrical energy. An inverter is provided. The inverter is connectable to receive input electric energy from the electric traction motor when the electric traction motor operates as a generator and operative to output electric charging energy in response to the input electric energy. A battery is provided. The battery is connectable to receive the electric charging energy from the inverter. In the MDC charging mode, MDC mechanical energy is generated by a MDC wireless power receiver and the MDC wireless power receiver is coupled to the electric traction motor to thereby transfer the MDC mechanical energy to the electric traction motor. In the RB charging mode, a drivetrain of the vehicle is coupled to the electric traction motor to thereby transfer RB mechanical energy to the electric traction motor.

Another aspect of the invention provides method of charging an electric vehicle in a magneto-dynamic coupling (MDC) charging mode and a regenerative braking (RB) charging mode, the method comprising. An electric traction motor is provided. The electric traction motor is for providing mechanical energy for propelling the vehicle. The electric traction motor is operable as a generator to convert received mechanical energy into electrical energy. An auxiliary generator is provided for converting received mechanical energy into electrical energy. An inverter is provided. The inverter is connectable to: (1) receive first input electric energy from the electric traction motor when the electric traction motor operates as a generator; and (2) receive second input electric energy from the auxiliary generator. The inverter is operative to output electric charging energy in response to the first input electric energy or the second input electric energy. A battery is connectable to receive the electric charging energy from the inverter. In the MDC charging mode, MDC mechanical energy is generated by a MDC wireless power receiver and the MDC wireless power receiver is coupled to the auxiliary generator to thereby transfer the MDC mechanical energy to the auxiliary generator. In the RB charging mode, a drivetrain of the vehicle is coupled to the electric traction motor to thereby transfer RB mechanical energy to the electric traction motor.

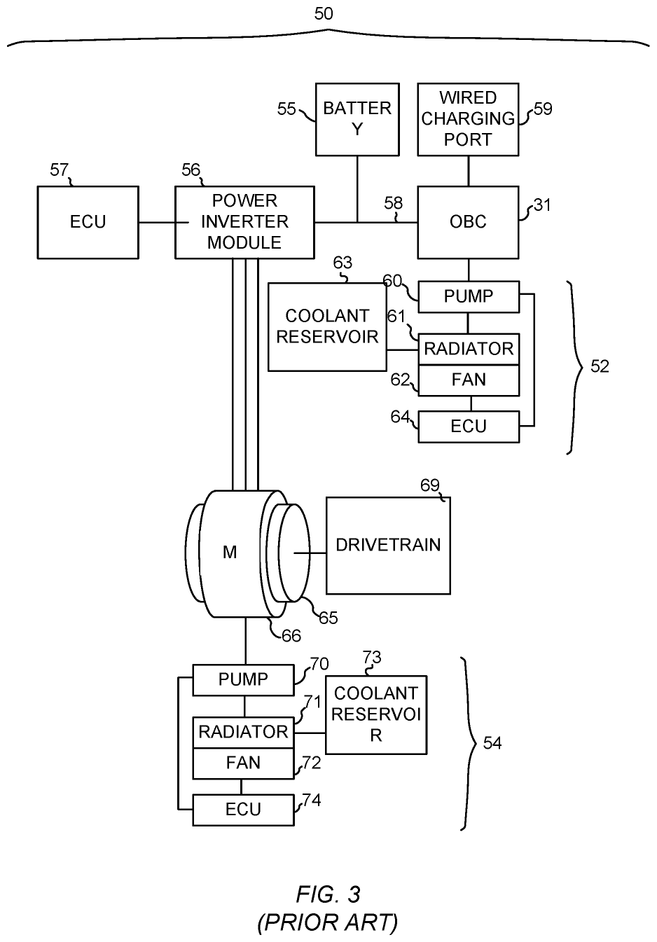

FIG. 3 depicts a simplified schematic block diagram of an exemplary powertrain 50 of an EV.

Powertrain 50 comprises an electric traction motor 65 for providing mechanical energy for propelling the EV. In some embodiments, electric traction motor 65 is operable as a generator to convert received mechanical energy (e.g. mechanical energy from a drivetrain 69 of the EV) into electric energy.

Drivetrain 69 of the EV may comprise, for example, a transmission or gearbox, one or more axles, one or more propeller shafts and/or other components for delivering power from electric traction motor 65 to the wheels of the EV (or to a propeller in the case of a boat or plane, or to a track in the case of a snowmobile or tractor or the like).

Powertrain 50 may comprise components for supplying energy to drive electric traction motor 65 such as a battery 55 for energy storage (e.g. DC energy storage), and a power inverter module 56 (also referred to as inverter 56) for converting DC energy from battery 55 to AC energy to drive electric traction motor 65.

In some embodiments, inverter 56 also allows vehicle kinetic energy to be recovered from traction motor 65 by using a regenerative braking charging mode, in which case mechanical energy flows from the drivetrain 69 (e.g. braking motion of the drive wheels) to traction motor 65 where the mechanical energy is converted into electric energy. Electrical energy is then transferred from electric traction motor 65 to inverter 56. Inverter 56 may convert AC energy from electric traction motor 65 to DC energy for storage in battery 55.

An electronic control unit (ECU) 57 may provide control and monitoring of inverter 56 and/or other components of powertrain 50 and/or with other EV control systems. When regenerative braking charging mode is selected, ECU 57 may send a signal to inverter 56 to activate this mode and use traction motor 65 as a generator allowing mechanical energy from slowing down the EV to charge battery 55.

Wired charging of battery 55 may also be employed using a wired charging port 59 and an board charger (OBC) 31. Wired charging port 59 may provide a connection to an electrical vehicle supply equipment (EVSE) separate from the EV. In some embodiments an EVSE is part of a charging station or ground assembly. OBC 31 and battery 55 may be connected by way of a high voltage (HV) DC bus 58.

A primary cooling system 54 may be provided to remove heat from electric traction motor 65. In some embodiments, heat is removed from electric traction motor 65 using an outer cooling sleeve 66 and primary cooling system 54. Primary cooling system may, for example, comprise a coolant loop consisting of a pump 70, a radiator 71, a fan 72, and a coolant reservoir 73. Electronic control unit (ECU) 74 controls operation of pump 70 and fan 72 for the regulation of coolant temperature to maintain traction motor 65 within a desired range of operating temperatures.

An optional secondary cooling system 52 may be provided to remove heat from OBC 31. Secondary cooling system 52 may comprise, for example, a secondary coolant loop (separate from primary cooling system 54) consisting of pump 60, radiator 61, fan 62, and coolant reservoir 63. Electronic control unit (ECU) 64 controls operation of pump 60 and fan 62 for the regulation of coolant temperature to maintain OBC 31 and any other secondary components that are desirable to maintain within a desired range of operating temperatures.

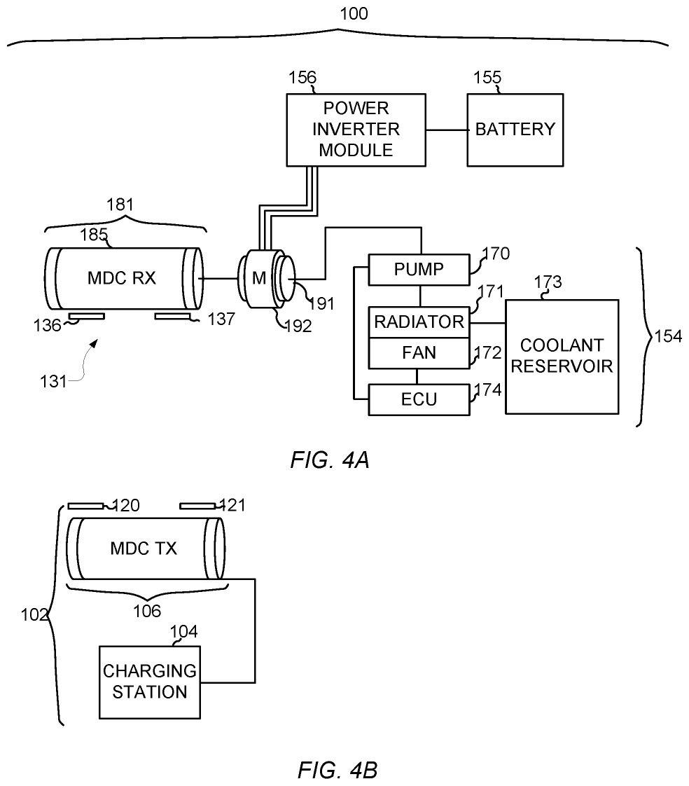

FIG. 4A depicts a wireless power receiving system 100. Wireless power receiving system 100 comprises an electric motor 191, a magneto-dynamic coupling (MDC) wireless power receiver 181, a power inverter module 156 (also referred to as inverter 156), a battery 155 connectable to receive and store the electric charging energy from inverter 156 and an optional cooling system 154.

Electric motor 191 may comprise any suitable electric motor operable as a generator to convert received mechanical energy into electrical energy.

MDC wireless power receiver 181 may comprise any suitable wireless power receiver. For example, MDC wireless power receiver 181 may comprise a rotor comprising one or more permanent magnets 185, the rotor mounted to move (e.g. mounted to be rotatable about an axis) in response to a magnetic field (e.g. a time-varying-magnetic field) of a wireless power transmitter. Exemplary MDC wireless power receivers are described in Patent Cooperation Treaty Patent Application No. PCT/CA2015/050736 filed 5 Aug. 2015 for MULTI-MODE CHARGING SYSTEM, Patent Cooperation Treaty Patent Application No. PCT/CA2015/050327 filed 20 Apr. 2015 for MAGNETIC FIELD CONFIGURATION FOR A WIRELESS ENERGY TRANSFER SYSTEM and Patent Cooperation Treaty Patent Application No. PCT/CA2015/050763 filed 13 Aug. 2015 for METHOD AND APPARATUS FOR MAGNETICALLY COUPLED WIRELESS POWER TRANSFER, each of which is hereby incorporated by reference herein in its entirety.

Inverter 156 may be any suitable inverter connected to receive input electric energy from the electric motor 191 when electric motor 191 operates as a generator and operative to output electric charging energy in response to the input electric energy.

In some embodiments, battery 155 is a component of the powertrain of an EV. In some embodiments, battery 155 may store DC energy and inverter 156 may convert such DC energy from battery 155 to AC energy to drive an electric traction motor of the EV. In some embodiments, inverter 156 may also receive AC energy from electric motor 191 when electric motor 191 operates as a generator and inverter 156 may convert such AC energy to DC energy for storage in battery 155.

Cooling system 154 may comprise any suitable cooling system for removing heat from electric motor 191. For example, in some non-limiting embodiments, cooling system 154 comprises a coolant loop consisting of a pump 170, a radiator 171, a fan 172, and a coolant reservoir 173. Electronic control unit (ECU) 174 controls operation of pump 170 and fan 172 for the regulation of coolant temperature to maintain auxiliary electric motor 191 within a desired range of operating temperatures. In some embodiments, a cooling sleeve 192 is attached to and/or fitted around electric motor 191 to remove heat from electric motor 191 and disperse such heat through cooling system 154.

In some embodiments, wireless power receiving system 100 comprises a proximity and alignment system 131. Proximity and alignment system 131 may comprise a first proximity transmission coil 136 and a second transmission coil 137. EV proximity and/or alignment may detected when first and second proximity receiver coils 120, 121 (as shown in FIG. 4B) of a ground assembly 102 receive signals from first and second proximity transmitter coils 136, 137 of proximity and alignment system 131 during the approach of the EV to ground assembly 102. It should be understood by a person of skill in the art that the transmission coils located in the EV could be swapped with the receiver coils of ground assembly 102.

FIG. 4B depicts a schematic block diagram of a ground assembly 102. Ground assembly 102 may comprise a MDC wireless power transmitter 106 and a charging station 104.

MDC wireless power transmitter 106 may comprise any suitable wireless power transmitter. For example, MDC wireless power transmitter 106 may comprise a rotor comprising one or more permanent magnets, the rotor mounted for movement (e.g. mounted to be rotatable about an axis) to generate a magnetic field (e.g. a time-varying-magnetic field) to couple to MDC wireless power receiver 181. Exemplary MDC wireless power transmitters are described in Patent Cooperation Treaty Patent Application No. PCT/CA2015/050736 filed 5 Aug. 2015 for MULTI-MODE CHARGING SYSTEM, Patent Cooperation Treaty Patent Application No. PCT/CA2015/050327 filed 20 Apr. 2015 for MAGNETIC FIELD CONFIGURATION FOR A WIRELESS ENERGY TRANSFER SYSTEM and Patent Cooperation Treaty Patent Application No. PCT/CA2015/050763 filed 13 Aug. 2015 for METHOD AND APPARATUS FOR MAGNETICALLY COUPLED WIRELESS POWER TRANSFER, each of which is hereby incorporated by reference herein in its entirety.

Charging station 104 may comprise, for example, a display panel and power unit. The power unit may comprise an AC supply power, a DC supply, a radio, a controller, a power factor correction (PFC) module, and a MDC transmitter drive to cause, for example, a rotor comprising one or more permanent magnets of MDC wireless power transmitter 106 to move (e.g. rotate about an axis).

One aspect of the invention provides wireless power receiving systems integrated with powertrains of EVs. Due to overlap in rotational operating frequencies of MDC wireless power receivers and vehicle traction motors, the MDC wireless power receiver may share an EV's electric traction motor, inverter and/or cooling systems thereby obviating the need for one or more of a dedicated electric generator, inverter and cooling system for the purposes of the wireless power receiving system. Such sharing may allow for significant cost, size and weight reductions when integrating a MDC wireless charging system with an EV. These applications of MDC wireless charging does not require a mechanical connection between the EV and a ground assembly and may therefore overcome limitations of prior art mechanical regenerative systems which require precise alignment between power transmitter and receiver. Since embodiments disclosed herein do not employ the drivetrain of the EV, the embodiments herein may not reduce the life of drive train components as is the case for some prior art charging systems.

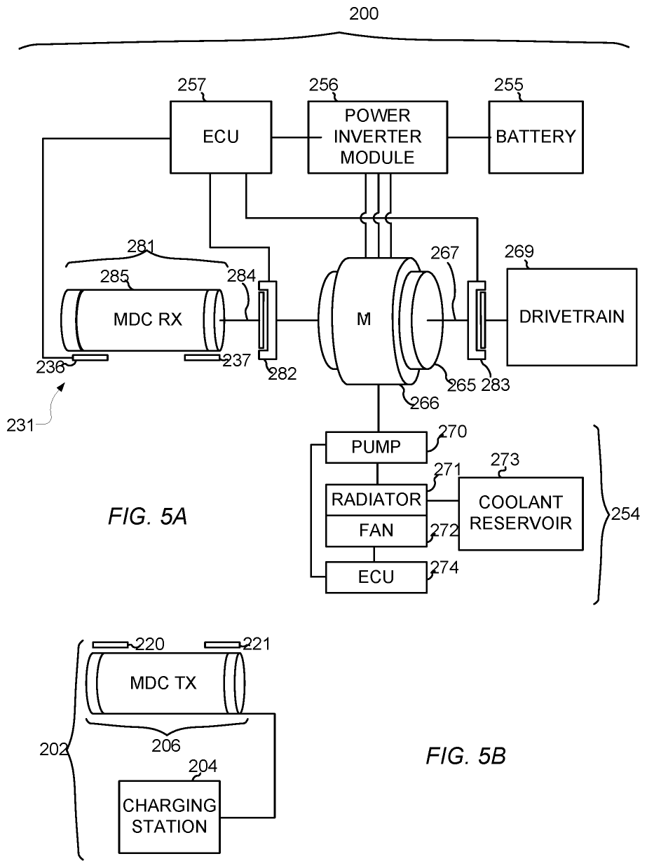

FIG. 5A depicts an exemplary embodiment of an integrated powertrain and wireless power receiving system 200 (also referred to as wireless power receiving system 200) for an EV. Similar to wireless power receiving system 100, wireless power receiving system 200 comprises a MDC wireless power receiver 281, an electric motor 265, an inverter 256, a battery 255 and a cooling system 254. However, unlike wireless power receiving system 100, electric motor 265 of wireless power receiving system 200 comprises an electric traction motor 265 that is part of the powertrain of the EV.

Electric traction motor 265 may comprise any suitable electric motor for providing mechanical energy for propelling the EV and operable as a generator to convert received mechanical energy into electrical energy.

Inverter 256, like inverter 156, may comprise any suitable power inverter module suitable to convert DC energy from battery 255 to AC energy to drive electric traction motor 265. In some embodiments, inverter 256 may also receive AC energy from electric traction motor 265 when electric traction motor 265 operates as a generator (as discussed further below) and inverter 256 may converts such AC energy to DC energy for storage in battery 255.

MDC wireless power receiver 281 may comprise any suitable wireless power receiver. MDC wireless power receiver 281 may be substantially similar to MDC wireless power receiver 181.

Wireless power receiving system 200 may comprise a MDC mechanical power transfer mechanism 284 connected to mechanically couple the MDC mechanical energy from MDC wireless power receiver 281 to electric traction motor 265 when wireless power receiving system 200 is in a MDC charging mode. In some embodiments, MDC mechanical power transfer mechanism 284 comprises a first clutch 282 connected between MDC wireless power receiver 281 and electric traction motor 265. First clutch 282 may be selectively engageable to mechanically couple MDC mechanical energy from MDC wireless power receiver 281 to electric traction motor 265 via a rotary connection between MDC wireless power receiver 281 and electric traction motor 265. First clutch 282 may also be selectively disengageable to mechanically decouple MDC wireless power receiver 281 from electric traction motor 265. ECU 257 may control first clutch 282 to engage first clutch 282 when wireless power receiving system 200 is in MDC charging mode and it is desirable to mechanically couple the MDC mechanical energy from MDC wireless power receiver 281 to electric traction motor 265 to charge battery 255. First clutch 282 may comprise, for example, an electromagnetic clutch or any other suitable clutch.

Wireless power receiving system 200 may comprise a regenerative braking (RB) mechanical power transfer mechanism 267 connected to mechanically couple RB mechanical energy from a drivetrain 269 of the EV to electric traction motor 265 when wireless power receiving system 200 is in a RB charging mode. In some embodiments, RB mechanical power transfer mechanism 267 comprises a second clutch 283 connected between drivetrain 269 and electric traction motor 265. Second clutch 283 may be selectively engageable to mechanically couple RB mechanical energy from drivetrain 269 to electric traction motor 265 via a rotary connection between drivetrain 269 and electric traction motor 265. Second clutch 283 may also be selectively disengageable to mechanically decouple drivetrain 269 from electric traction motor 265. ECU 257 may control second clutch 283 to engage second clutch 283 when wireless power receiving system 200 is in RB charging mode and it is desirable to mechanically couple RB mechanical energy from a drivetrain 269 of the EV to electric traction motor 265 to charge battery 255. Second clutch 283 may comprise, for example, an electromagnetic clutch or any other suitable clutch.

Wireless power receiving system 200 may optionally comprise a cooling system 254 for removing heat from electric traction motor 265. Cooling system 254 may be operable to remove heat from electric traction motor 265 when wireless power receiving system 200 is in MDC charging mode, RB charging mode or when electric traction motor 265 provides mechanical energy to drivetrain 269 for propelling the EV. In this way, a single cooling system 254 may provide the function of, for example, cooling system 154 of wireless power receiving system 100 and cooling system 54 of powertrain 50.

In some embodiments, a cooling sleeve 266 is attached to and/or fitted around electric traction motor 265 to remove heat from electric traction motor 265 and disperse such heat through cooling system 254. Cooling system 254 may comprise any suitable cooling system for removing heat from electric traction motor 265. For example, in some non-limiting embodiments, cooling system 254 comprises a coolant loop consisting of a pump 270, a radiator 271, a fan 272, and a coolant reservoir 273. Electronic control unit (ECU) 274 controls operation of pump 270 and fan 272 for the regulation of coolant temperature to maintain electric traction motor 265 within a desired range of operating temperatures.

In some embodiments, wireless power receiving system 200 comprises a proximity and alignment system 231. Proximity and alignment system 231 may comprise a first proximity transmission coil 236 and a second transmission coil 237. EV proximity and/or alignment may detected when first and second proximity receiver coils 220, 221 (as shown in FIG. 5B) of a ground assembly 202 receive signals from first and second proximity transmitter coils 236, 237 of proximity and alignment system 231 during the approach of the EV to ground assembly 202. It should be understood by a person of skill in the art that the transmission coils located in the EV could be swapped with the receiver coils of ground assembly 202. Proximity and alignment system 231 may be substantially similar to proximity and alignment system 131.

In practice, when proximity and alignment system 231 detects that MDC wireless power receiver 281 is sufficiently aligned with MDC wireless transmitter 206, alignment system 231 may send a signal to ECU 257 indicating that wireless power receiving system 200 should switch to MDC charging mode. Alternatively, in the absence of alignment system 231, a user could manually tell ECU 257 to switch to MDC charging mode. Similarly, MDC wireless power transmitter may begin transmitting either due to manual input or automatically in response to alignment or proximity of MDC wireless power receiver as determined by receiving coils 220, 221. ECU 257 may then send a signal to first clutch 282 to engage such that mechanical energy of MDC wireless power receiver 281 (that is received from MDC wireless power transmitter 206) is transferred to electric traction motor 265. ECU 257 may also send a signal to second clutch 283 to disengage second clutch 283 to prevent mechanical energy from MDC wireless power receiver being transferred undesirably to drivetrain 269 via electric traction motor 265 or otherwise. ECU 257 may also send a signal to inverter 256 to cause inverter 256 to convert energy received from electric traction motor 265 into a suitable form for battery 255 (e.g. to convert AC energy received from electric traction motor 265 to DC energy for battery 255).

When proximity and alignment system 231 detects that MDC wireless power receiver 281 is no longer proximate to MDC wireless transmitter 206, alignment system 231 may send a signal to ECU 257 indicating that wireless power receiving system 200 should switch to RB charging mode. Alternatively, in the absence of alignment system 231, a user could manually tell ECU 257 to switch to RB charging mode. ECU 257 may then send a signal to first clutch 282 to disengage first clutch 282 to prevent mechanical energy from drivetrain 269 being transferred undesirably to MDC wireless power receiver 281 via electric traction motor 265 or otherwise. ECU 257 may also send a signal to second clutch 283 to engage second clutch 283 such that mechanical energy of drivetrain 269 is transferred to electric traction motor 265. ECU 257 may constantly monitor wireless power receiving system 200 to determine whether to send a signal to inverter 256 to cause inverter 256 to convert energy received from electric traction motor 265 into a suitable form for battery 255 (e.g. to convert AC energy received from electric traction motor 265 to DC energy for battery 255) or to send a signal to inverter 256 to cause inverter 256 to convert energy received from battery 255 into a suitable form to drive electric traction motor 265 (e.g. to convert DC energy received from battery 255 to AC energy to power electric traction motor 265).

FIG. 5B depicts a schematic block diagram of a ground assembly 202. Ground assembly 202 may be substantially similar to ground assembly 102 and may comprise a MDC wireless power transmitter 206 and a charging station 204 like MDC wireless power transmitter 106 and charging station 104.

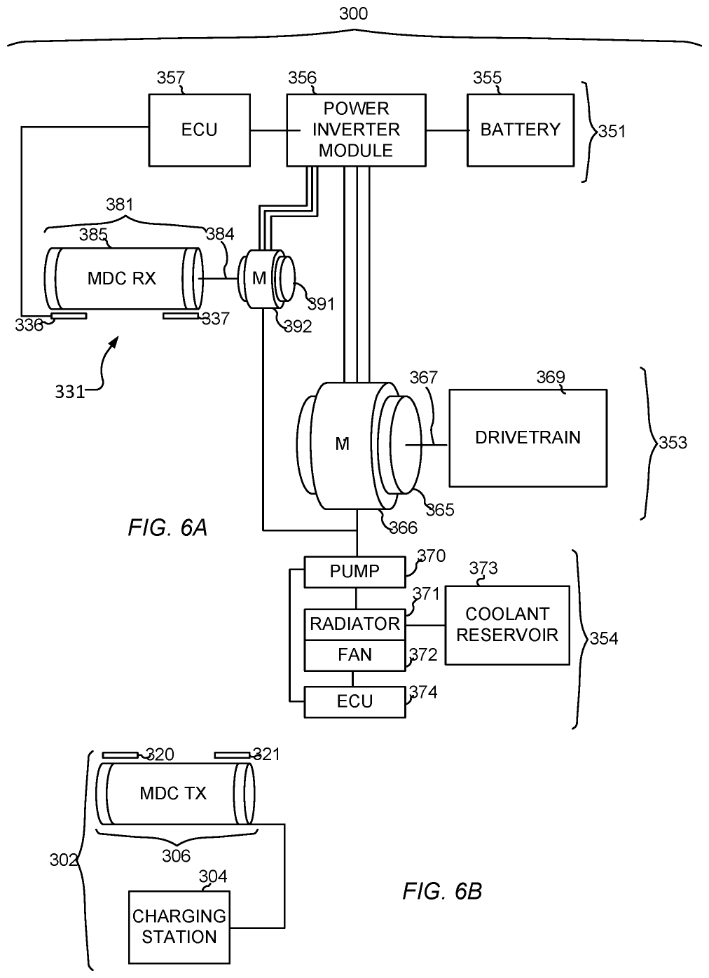

FIG. 6A depicts an exemplary embodiment of an integrated powertrain and wireless power receiving system 300 (referred to herein as wireless power receiving system 300) for an EV. Wireless power receiving system 300 is substantially similar to wireless power receiving system 200 (e.g. wireless power receiving system 300 comprises an electric traction motor 365 similar to electric traction motor 265, an inverter 356 similar to inverter 256, a battery 355 similar to battery 255, a drivetrain 369 similar to drive 269 and a MDC wireless power receiver 381 similar to MDC wireless power receiver 281) except that in the MDC charging mode of wireless power receiving system 200, a separate electric auxiliary generator 391 receives mechanical energy from MDC wireless power receiver 381 instead of the electric traction motor 365 receiving mechanical energy from MDC wireless power receiver 381, as described below.

Wireless power receiving system 300 may comprise a MDC mechanical power transfer mechanism 384 connected to mechanically couple the MDC mechanical energy from MDC wireless power receiver 381 to electric auxiliary generator 391 when wireless power receiving system 300 is in a MDC charging mode.

Wireless power receiving system 300 may comprise a regenerative braking (RB) mechanical power transfer mechanism 367 connected to mechanically couple RB mechanical energy from a drivetrain 369 of the EV to electric traction motor 365 when wireless power receiving system 300 is in a RB charging mode.

Wireless power receiving system 300 may optionally comprise a cooling system 354 for removing heat from electric traction motor 365 and/or electric auxiliary generator 391. Cooling system 354 may be operable to remove heat from electric auxiliary generator 391 when wireless power receiving system 300 is in MDC charging mode, from electric traction motor 365 when wireless power receiving system 300 is in RB charging mode or from electric traction motor 365 when electric traction motor 365 provides mechanical energy to drivetrain 369 for propelling the EV. In this way, a single cooling system 354 may provide the function of, for example, cooling system 154 of wireless power receiving system 100 and cooling system 54 of powertrain 50.

In some embodiments, a cooling sleeve 366 is attached to and/or fitted around electric traction motor 365 to remove heat from electric traction motor 365 and disperse such heat through cooling system 354. In some embodiments, a cooling sleeve 392 is attached to and/or fitted around electric auxiliary generator 391 to remove heat from electric auxiliary generator 391 and disperse such heat through cooling system 354. Cooling system 354 may comprise any suitable cooling system for removing heat from electric traction motor 365. For example, in some non-limiting embodiments, cooling system 354 comprises a coolant loop consisting of a pump 370, a radiator 371, a fan 372, and a coolant reservoir 373. Electronic control unit (ECU) 374 controls operation of pump 370 and fan 372 for the regulation of coolant temperature to maintain electric traction motor 365 within a desired range of operating temperatures.

In some embodiments, wireless power receiving system 300 comprises a proximity and alignment system 331. Proximity and alignment system 331 may comprise a first proximity transmission coil 336 and a second transmission coil 337. EV proximity and/or alignment may detected when first and second proximity receiver coils 320, 321 (as shown in FIG. 6B) of a ground assembly 302 receive signals from first and second proximity transmitter coils 336, 337 of proximity and alignment system 331 during the approach of the EV to the ground assembly 302. Proximity and alignment system may comprise any one of the proximity and alignment systems described in U.S. provisional application 62/644,788 filed on 19 Mar. 2018 which is hereby incorporated herein by reference in its entirety.

In practice, when proximity and alignment system 331 detects that MDC wireless power receiver 381 is sufficiently aligned with MDC wireless transmitter 306, alignment system 331 may send a signal to ECU 357 indicating that wireless power receiving system 300 should switch to MDC charging mode. Alternatively, in the absence of alignment system 331, a user could manually tell ECU 357 to switch to MDC charging mode. Similarly, MDC wireless power transmitter may begin transmitting either due to manual input or automatically in response to alignment or proximity of MDC wireless power receiver as determined by receiving coils 320, 321. ECU 357 may send a signal to inverter 356 to cause inverter 356 to convert energy received from electric auxiliary generator 391 into a suitable form for battery 355 (e.g. to convert AC energy received from electric auxiliary generator 391 to DC energy for battery 355).

When proximity and alignment system 331 detects that MDC wireless power receiver 381 is no longer proximate to MDC wireless transmitter 306, alignment system 331 may send a signal to ECU 357 indicating that wireless power receiving system 300 should switch to RB charging mode. Alternatively, in the absence of alignment system 331, a user could manually tell ECU 357 to switch to RB charging mode. ECU 357 may constantly monitor wireless power receiving system 300 to determine whether to send a signal to inverter 356 to cause inverter 356 to convert energy received from electric traction motor 365 into a suitable form for battery 355 (e.g. to convert AC energy received from electric traction motor 365 to DC energy for battery 355) or to send a signal to inverter 356 to cause inverter 356 to convert energy received from battery 355 into a suitable form to drive electric traction motor 365 (e.g. to convert DC energy received from battery 355 to AC energy to power electric traction motor 365).

FIG. 6B depicts a schematic block diagram of a ground assembly 302. Ground assembly 302 may be substantially similar to ground assembly 102 and ground assembly 202 and may comprise a MDC wireless power transmitter 306 and a charging station 304 like MDC wireless power transmitter 106 and charging station 104.

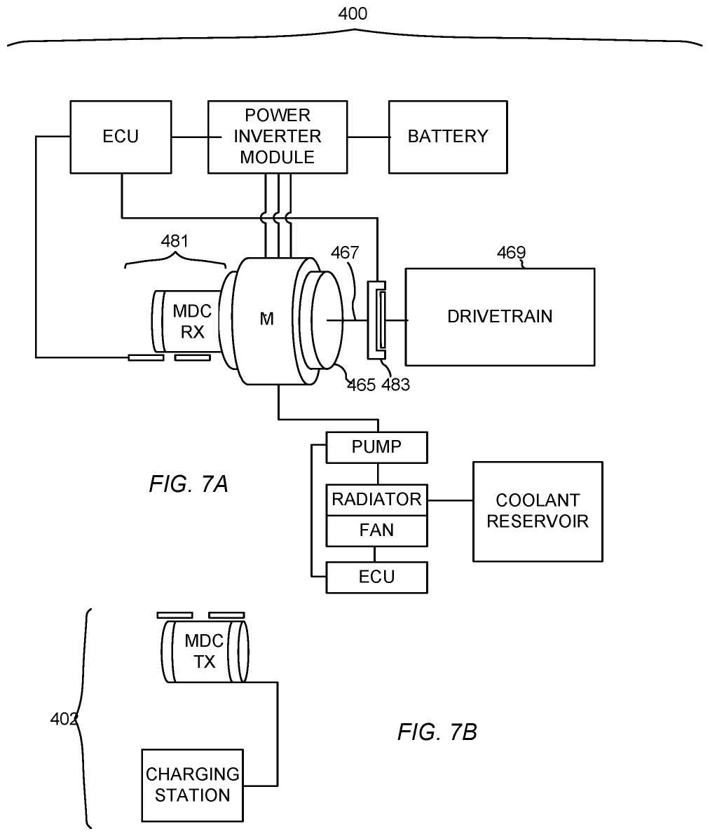

FIG. 7A depicts an exemplary embodiment of an integrated powertrain and wireless power receiving system 400 (referred to herein as wireless power receiving system 300) for an EV. Wireless power receiving system 400 is substantially similar to wireless power receiving system 200 (e.g. wireless power receiving system 400 comprises an electric traction motor 465 similar to electric traction motor 265, an inverter similar to inverter 256, a battery similar to battery 255, a drivetrain 469 similar to drive 269, a regenerative braking (RB) mechanical power transfer mechanism 467 similar to RB mechanical power transfer mechanism 267, a clutch 483 similar to second clutch 283 and a MDC wireless power receiver 481 similar to MDC wireless power receiver 281) except that MDC wireless power receiver 481 is directly coupled to electric traction motor 465 to thereby directly couple the MDC mechanical energy from MDC wireless power receiver 481 to electric traction motor 465 in a MDC charging mode and in a RB charging mode of wireless power receiving system 400.

In some embodiments, a rotor (comprising one or more permanent magnets) of MDC wireless power receiver 481 is directly coupled to electric traction motor 465. In some embodiments, the rotor of MDC wireless power receiver 481 is directly coupled to a drive shaft of electric traction motor 465. In some embodiments, the rotor of MDC wireless power receiver 481 is directly integrated into electric traction motor 465. In some embodiments, the rotor of MDC wireless power receiver 481 or MDC wireless power receiver 481 itself is housed within a common casing with electric traction motor 465.

As compared to wireless power receiving system 200, wireless power receiving system 400 includes fewer parts (e.g. wireless power receiving system 400 does not comprise a first clutch 282 or a MDC mechanical power transfer mechanism 284). Such reduction in parts may reduce the volumetric footprint, cost and weight of wireless power receiving system 400. In practice, wireless power receiving system 200 and wireless power receiving system 400 operate in a substantially similar manner except that MDC wireless power receiver 481 is not disengaged in RB charging mode and MDC wireless power receiver 481 (or a portion thereof) moves (e.g. rotates) with rotation of a drive shaft of electric traction motor 465 in RB charging mode and/or when electric traction motor 465 drives the EV.

There are numerous advantages to the disclosed wireless power receiving systems 100, 200, 300, 400. For example, such embodiments described and/or depicted herein:
may reduce the cost, weight and/or volume of a wireless charging system integrated in an EV;
allow for the rapid charging of the EV using the traction motor and regen system, at rates equal to or above that provided by the conventional wired charging system which was displaced; and
allow the EV to be positioned with less accuracy requirements than prior art systems which used direct mechanical coupling to the vehicle traction motor and regenerative systems, allowing the system to be used within the typical positioning accuracy achieved by human drivers and autonomous driving systems.

Wireless power transfer systems, components and methods in accordance with various embodiments of the invention described herein may be used in any magnetically-coupled wireless charging system for, but not limited to, electric powered automobiles, transit buses, delivery vehicles, trucks, drones, boats, golf carts or other consumer devices and mobile applications. Wireless power transfer systems and methods in accordance with various embodiments of the invention reduce vibration and noise observed in wireless charging systems with single magnet rotors and allow for high power transfer rates and longer operating life.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof; elements which are integrally formed may be considered to be connected or coupled;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the present invention include various operations, which are described herein. These operations may be performed by hardware components, software, firmware, or a combination thereof.

Certain embodiments may be implemented as a computer program product that may include instructions stored on a machine-readable medium. These instructions may be used to program a general-purpose or special-purpose processor to perform the described operations. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Computer processing components used in implementation of various embodiments of the invention include one or more general-purpose processing devices such as a microprocessor or central processing unit, a controller, graphical processing unit (GPU), cell computer, or the like. Alternatively, such digital processing components may include one or more special-purpose processing devices such as a digital signal processor (DSP), an application specific integrated circuit (ASIC), a field programmable gate array (FPGA), or the like. In particular embodiments, for example, the digital processing device may be a network processor having multiple processors including a core unit and multiple microengines. Additionally, the digital processing device may include any combination of general-purpose processing device(s) and special-purpose processing device(s).

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments. In particular:
while wireless power receiving systems 100, 200, 300, 400 as described herein do not comprise wired charging systems (e.g. as shown in and described in reference to FIG. 3), it should be understood by a person of skill in the art that such systems could also be included in the wireless power receiving systems described herein.
The batteries described herein may be any suitable batteries including, but not limited to Model EVB1-400-40 by BRUSA Elektronik AG.
The inverters described herein may be any suitable inverters including, but not limited to, Model DMC524 by BRUSA Elektronik AG.
The electric motors herein may be any suitable electric motors including, but not limited to, an asynchronous motor such as model ASM1-6.17.12 by BRUSA
Elektronik AG, an AC permanent magnet motor, an induction motor, or a 3-phase synchronous machine.
The OBCs described herein may be any suitable OBCs including, but not limited to, Model HPC22KL from EDN Group S.R.L.
The EVSEs described herein may be any suitable EVSEs including, but not limited to, an AC level 1 or level 2 SAE J1772™ charging station.

1. A wireless power receiving system for an electric vehicle, the system comprising:
an electric traction motor for providing mechanical energy for propelling the vehicle, the electric traction motor operable as a generator to convert received mechanical energy into electrical energy;
an inverter connectable to receive input electric energy from the electric traction motor when the electric traction motor operates as a generator and operative to output electric charging energy in response to the input electric energy; and
a battery connectable to receive the electric charging energy from the inverter;
a magneto-dynamic coupling (MDC) wireless power receiver wirelessly magnetically couplable to a MDC wireless power transmitter for generating MDC mechanical energy by the magnetic coupling;
a regenerative braking (RB) mechanical power transfer mechanism connected to mechanically couple RB mechanical energy from a drivetrain of the electric vehicle to the electric traction motor when the system is in a RB charging mode; and
a MDC mechanical power transfer mechanism connected to mechanically couple the MDC mechanical energy from the MDC wireless power receiver to the electric traction motor when the system is in a MDC charging mode.

2. A system according to claim 1 wherein the MDC mechanical power transfer mechanism comprises a first clutch connected between the MDC wireless power receiver and the electric traction motor, the first clutch selectively:
engageable to mechanically couple the MDC mechanical energy from the MDC wireless power receiver to the electric traction motor via a first rotary connection between the MDC wireless power receiver and the electric traction motor; and
disengageable to mechanically decouple the MDC wireless power receiver from the electric traction motor.

3. A system according to claim 1 wherein the RB mechanical power transfer mechanism comprises a second clutch connected between the drivetrain and the electric traction motor, the second clutch selectively:
engageable to mechanically couple the RB mechanical energy from the drivetrain to the electric traction motor via a second rotary connection between the drivetrain and the electric traction motor; and
disengageable to mechanically decouple the drivetrain from the electric traction motor.

4. A system according to claim 1 comprising a cooling system connected to remove heat from the electric traction motor when the system is in the MDC charging mode.

5. A system according to claim 4 wherein the cooling system is connected to remove heat from the electric traction motor when the system is in the RB charging mode and the cooling system is connected to remove heat from the electric traction motor when the electric traction motor provides mechanical energy to the drivetrain for propelling the vehicle.

6. A system according to claim 4 wherein the cooling system is connected to remove heat from the inverter.

7. A system according to claim 1 comprising a proximity system comprising a proximity transmitter for generating signals which are receivable by a detector of a charging station to position the MDC wireless power receiver relative to the charging station to achieve effective energy transfer between a MDC wireless power transmitter of the charging station and the MDC wireless power receiver.

8. A system according to claim 7 comprising an electronic control unit configured to switch from the RB charging mode to the MDC charging mode in response to a first signal from the proximity system.

9. A system according to claim 7 wherein the electronic control unit is configured to switch from the MDC charging mode to the RB charging mode in response to a second signal from the proximity system.

10. A system according to claim 1 wherein the MDC wireless power receiver comprises a rotor comprising one or more permanent magnets rotatable about an axis in response to a magnetic field.

11. An electric vehicle comprising the wireless power receiving system for an electric vehicle according to claim 1.

12. A method of charging an electric vehicle in a magneto-dynamic coupling (MDC) charging mode and a regenerative braking (RB) charging mode, the method comprising:
providing:
an electric traction motor for providing mechanical energy for propelling the vehicle, the electric traction motor operable as a generator to convert received mechanical energy into electrical energy;
an inverter connectable to receive input electric energy from the electric traction motor when the electric traction motor operates as a generator and operative to output electric charging energy in response to the input electric energy; and
a battery connectable to receive the electric charging energy from the inverter;
in the MDC charging mode, generating MDC mechanical energy by a MDC wireless power receiver magnetically coupled to a MDC wireless power transmitter to thereby generate the MDC mechanical energy and coupling the MDC wireless power receiver to the electric traction motor and thereby transferring the MDC mechanical energy to the electric traction motor; and
in the RB charging mode, coupling a drivetrain of the vehicle to the electric traction motor and thereby transferring RB mechanical energy to the electric traction motor.

13. A method according to claim 12 wherein coupling the MDC wireless power receiver to the electric traction motor comprises engaging a first clutch.

14. A method according to claim 12 wherein coupling the drivetrain to the electric traction motor comprises engaging a second clutch.

15. A method according to 14 comprising, in the MDC charging mode, disengaging the second clutch to mechanically decouple the drivetrain from the electric traction motor.

16. A method according 13 comprising, in the RB charging mode, disengaging the first clutch to mechanically decouple the MDC wireless power receiver from the electric traction motor.

17. A method according to 12 wherein the electric vehicle comprises a cooling system and the method comprises, in the MDC charging mode, using the cooling system to remove heat from the electric traction motor.

18. A method according to 17 comprising, in the RB charging mode, using the cooling system to remove heat from the electric traction motor and using the cooling system to remove heat from the electric traction motor while the electric traction motor provides mechanical power to the drivetrain.

19. A method according to claim 17 comprising using the cooling system to remove heat from the inverter.

20. A method according to claim 12 comprising transmitting signals from a proximity transmitter of a proximity system in the vehicle to a detector of a charging station to position the MDC wireless power receiver relative to a MDC wireless power transmitter of the charging station to achieve effective energy transfer between the MDC wireless power transmitter of the charging station and the MDC wireless power receiver.

21. A method according to claim 20 comprising switching from the RB charging mode to the MDC charging mode in response to a first signal from the proximity system.

22. A method according to claim 20 comprising switching from the MDC charging mode to the RB charging mode in response to a second signal from the proximity system.

23. A wireless power receiving system for an electric vehicle, the system comprising:
an electric motor operable as a generator to convert received mechanical energy into electrical energy;
an inverter that is part of a regenerative braking (RB) system of the vehicle, the inverter connectable to receive input electric energy from the electric motor when the electric motor operates as a generator and operative to output electric charging energy in response to the input electric energy; and
a battery connectable to receive the electric charging energy from the inverter;
a magneto-dynamic coupling (MDC) wireless power receiver wirelessly magnetically couplable to a MDC wireless power transmitter for generating MDC mechanical energy by the magnetic coupling;
a MDC mechanical power transfer mechanism connected to mechanically couple the MDC mechanical energy from the MDC wireless power receiver to the electric motor when the system is in a MDC charging mode.
